(19) United States
(12) Patent Application Publication
(10) Pub. No.: US 2013/0160924 A1
(43) Pub. Date: Jun. 27, 2013

(54) HOT AIR TUNNEL SYSTEM APPARATUS AND LABELING METHOD USING SAME

(71) Applicants: Taebyoung OH, Suwon-si (KR); Tae Houng JEONG, Covington, GA (US)

(72) Inventors: Taebyoung OH, Suwon-si (KR); Tae Houng JEONG, Covington, GA (US)

(73) Assignees: SKC CO., LTD., Suwon-si (KR); SKC INC., Covington, GA (US)

(21) Appl. No.: 13/336,366

(22) Filed: Dec. 23, 2011

(51) Int. Cl. B65C 3/00; B65C 9/26

(52) U.S. Cl. 156/84; 156/498

(57) ABSTRACT

A hot air tunnel system apparatus comprising a preheating zone, a labeling zone, and a cooling zone with a transporting member provided through the lower parts of said zones to convey a product to be labeled from the preheating zone to the cooling zone, wherein each zone is equipped with fan heaters on both sides and on the bottom thereof, and also equipped with an air circulation system on the top thereof, which can minimize such labeling defects as loose labels, film curl, and irregular shrinkage when polyethylene-based products are labeled with heat-shrinkable labels.

### FIELD OF THE INVENTION

The present invention relates to a hot air tunnel system apparatus that enables labeling of polyethylene-based packaging with heat-shrinkable labels and a labeling method using same.

### BACKGROUND OF THE INVENTION

Polyethylene (PE) is widely used in different applications due to its good moldability, particularly high-density polyethylene (HDPE) is widely used for packaging of household items such as shampoo and lotion owing to its excellent durability and mechanical properties. Polyethylene, especially HDPE, has a high thermal expansion coefficient and begins to expand around 50° C.

Meanwhile, various label forms are in use for plastic products to provide information such as names and contents. Self-adhesive paper labels were largely used traditionally; heat-shrinkable labels have recently become more popular to accommodate the needs for different types of printings to attract customers' attention or to be used for a full wrapping, which provides more information. Polyester-based films are generally used in the production of heat-shrinkable labels because of their characteristics that enable them to shrink around 70° C. to return to their original states once they have been stretched and orientated.

A hot air tunnel system apparatus is used for labeling plastic products with heat-shrinkable labels. The labeling process comprises loosely covering a plastic product with a heat-shrinkable label, and then passing the plastic product through a hot air tunnel where the label shrinks to fit tightly around the product. Conventional hot air tunnel system apparatuses for labeling comprise 1 or 2 zones.

FIGS. 3 and 4 illustrate examples of conventional hot air tunnel system apparatuses. In FIG. 3, a conventional hot air tunnel system apparatus (2) is provided with a transporting member (20), which conveys a product to be labeled through (100) a labeling zone (12) where hot air is blown to shrink the label. In FIG. 4, another conventional hot air tunnel system apparatus (3) is provided with a transporting member (20), which conveys a product through (100) both a preheating zone (11) and a labeling zone (12) to preheat the product with hot air and to shrink the label, respectively.

However, heat-shrink labeling of polyethylene-based products such as HDPE products in a conventional system apparatus may involve such problems as loose labels, film curl, or irregular shrinkage because preheating and cooling stages of the polyethylene-based products are not employed. FIG. 5 demonstrates how loose labels are produced in a conventional hot air tunnel having 1 or 2 zones only. A polyethylene-based product is loosely covered with a heat-shrinkable label (A1); the product is conveyed through a hot air tunnel for heat-shrink labeling (A2); the heat-shrinkable label shrinks to fit tightly around the product while the polyethylene-based product is expanded (A3); the polyethylene-based product shrinks at room temperature, preventing the label from fitting tightly around the product (A4); and, as a result, a loose label is produced (A5). Also, a failure to provide uniform hot air in the tunnel could cause irregular shrinkage.

Thus, there is a need for a novel heat-shrink labeling system to improve the quality of heat-shrink labeling.

### SUMMARY OF THE INVENTION

Accordingly, it is an object of the present invention to provide a novel hot air tunnel system apparatus and a labeling method using same to prevent labeling defects such as loose labels or irregular shrinkage.

In accordance with one aspect of the present invention, there is provided a hot air tunnel system apparatus, which comprises, in sequence, a preheating zone, a labeling zone, and a cooling zone, wherein the hot air tunnel system apparatus further comprises: a transporting member provided through the lower parts of said zones to convey a product in the direction from the preheating zone to the cooling zone, fan heaters provided on both sides and the bottom of each of the zones to blow hot air in each of the zones, and an air circulation system provided on the top of each of said zones to circulate hot air in each of said zones.

In accordance with another aspect of the present invention, there is provided a method for labeling a product with a heat-shrinkable label in the hot air tunnel system apparatus, which method comprises, in sequence, the steps of: (a) preheating the product covered with the heat-shrinkable label in the preheating zone; (b) subjecting the heat-shrinkable label to shrinkage to fit around the product; and (c) cooling the product covered with the heat-shrunk label in the cooling zone.

The hot air tunnel system apparatus of the present invention can minimize labeling defects such as loose labels, film curling and irregular shrinkage by employing said three zones, i.e., the preheating zone that minimizes the expansion of the product to be labeled; the labeling zone that allows heat-shrinkable label to shrink uniformly around the product; and the cooling zone that prevents loose labels.

### BRIEF DESCRIPTION OF THE DRAWINGS

The above and other objects and features of the present invention will become apparent from the following description of the invention, when taken in conjunction with the accompanying drawings, which respectively show:

FIGS. 1 and 2 illustrate the entire structure of the hot air tunnel system apparatus according to the present invention and the inside of each zone contained therein, respectively (1: hot air tunnel system apparatus, 11: preheating zone, 12: labeling zone, 13: cooling zone, 14: air circulation system, 20: transporting member, 30: product to be labeled, 100: direction of progress, and 200: flow of hot air).

FIGS. 3 and 4 depict conventional hot air tunnel system apparatuses (2 and 3: hot air tunnel system apparatuses, 11: preheating zone, 12: labeling zone, 20: transporting member, and 100: direction of progress).

FIG. 5 shows how loose labels are produced during heat-shrink labeling in a conventional hot air tunnel system apparatus.

### DETAILED DESCRIPTION OF THE INVENTION

The hot air tunnel system apparatus of the present invention is a hot air tunnel system apparatus for labeling a polyethylene-based product with a heat-shrinkable label.

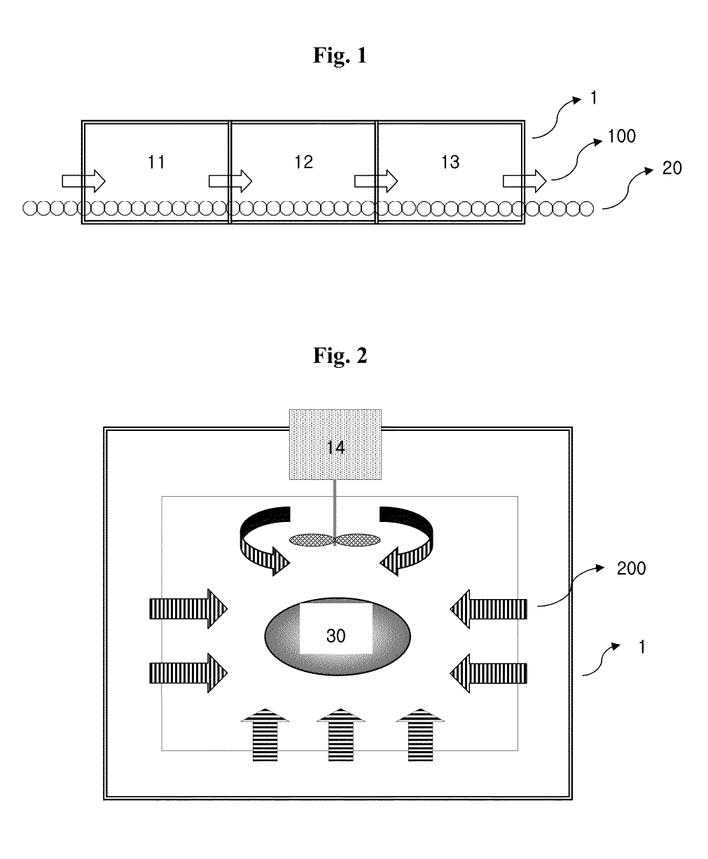

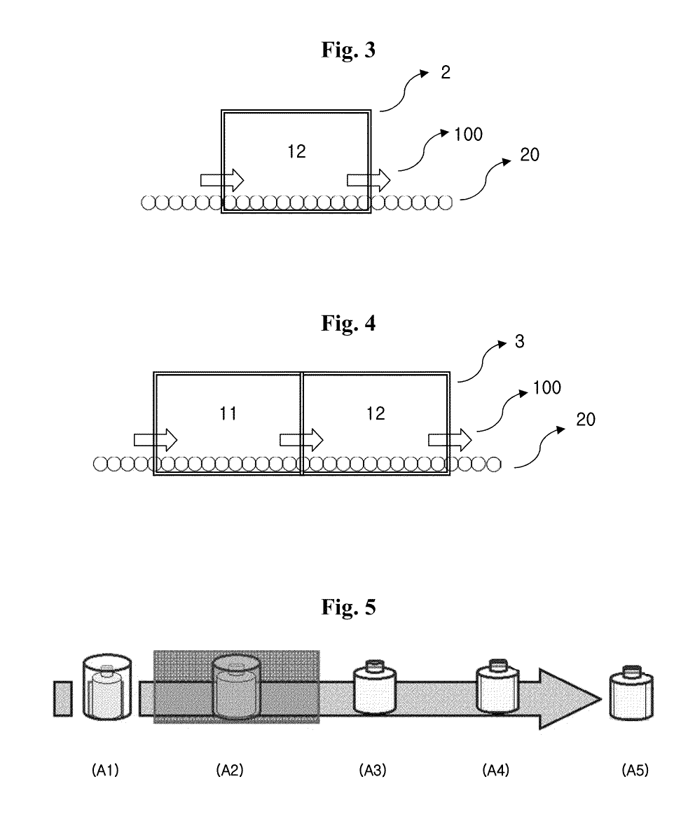

FIG. 1 shows the entire structure of the hot air tunnel system apparatus of the present invention, and FIG. 2 is a vertical cross section taken perpendicular to the direction of progress, which shows the inside of each zone.

The hot air tunnel system apparatus (1) of the present invention comprises a preheating zone (11), a labeling zone (12), a cooling zone (13), and a transporting member (20), wherein the preheating zone (11) preheats a product to be labeled; the labeling zone (12) shrinks a heat-shrinkable label to fit tightly around the product; the cooling zone (13) cools the labeled product; and the transporting member (20) conveys the product through (100) the preheating zone (11), the labeling zone (12), and the cooling zone (13) in sequence to carry out the heat-shrink labeling.

Thus, the hot air tunnel system apparatus (1) includes at least 3 zones; however, it may further comprise one or more zones for preheating, labeling, cooling, or for other purposes, if necessary.

The temperature in the preheating zone (11) of the hot air tunnel system apparatus (1) according to the present invention is preferably between 50 and 70° C. so as to minimize the expansion of the polyethylene-based product before the heat-shrinkable label shrinks to fit around the product.

Further, the temperature in the labeling zone (12) is preferably between 100 and 140° C. in order for the heat-shrinkable label to shrink more uniformly.

Furthermore, the temperature in the cooling zone (13) is preferably between 60 and 80° C. so as to minimize the production of loose labels.

Each of the preheating zone (11), the labeling zone (12) and the cooling zone (13) is preferably equipped with an air circulation system on the top of each zone for air circulation and is preferably equipped with fan heaters on both sides and the bottom of each zone. The fan heaters can blow a flow of hot air (200) from both sides and from the bottom of each zone. The air circulation system (14) can circulate hot air thoroughly in each zone to allow uniform shrinkage of the label around the product (30). The air circulation system (14) may be any suitable type known in the art, and the configuration and style thereof are not limited as long as it can uniformly circulate hot air inside each zone.

For the transporting member (20), a typical conveyer belt, for example, may be used, and the speed of the transporting member can be controlled so that the product to be labeled preferably stays in each zone (11, 12, and 13) from 3 seconds to 2 minutes.

Further, the flow rate of hot air is preferably from 10 m/s to 40 m/s.

Further, the temperature deviation inside each zone (11, 12, and 13) is preferably small. For instance, the temperature difference of 4° C. or lower inside each zone is desirable for uniform shrinkage of a heat-shrinkable label.

Further, it is preferable to rotate the product to be labeled in each zone to allow uniform shrinkage of a heat-shrinkable label.

The hot air tunnel system apparatus of the present invention may be used to label a product with a heat-shrinkable label, for example, to label a polyethylene-based product with a heat-shrinkable label.

The method of the present invention comprises, in sequence, the steps of: (a) preheating a product loosely covered with a heat-shrinkable label; (b) subjecting the preheated product to exposure to hot air; and (c) cooling the labeled product.

Further, the preferable temperatures in steps (a), (b), and (c) above may correspond to the aforementioned preferable temperatures of the preheating zone (11), the labeling zone (12), and the cooling zone (13) of the hot air tunnel system apparatus of the present invention, respectively.

Further, the preferable residence times of a product in steps (a), (b), and (c) above may correspond to the aforementioned preferable residence times in the preheating zone (11), labeling zone (12), and cooling zone (13) of the hot air tunnel system apparatus of the present invention, respectively.

Further, the preferable flow rate of hot air and the temperature deviation in each zone may also correspond to the preferable ranges employed in the hot air tunnel system apparatus of the present invention, respectively.

Suitable products that may be labeled by the hot air tunnel system apparatus of the present invention are preferably polyethylene-based products, more preferably HDPE-based products. The shape of the products may vary (such as a bottle, container, or box) depending on their usage.

Further, the heat-shrinkable label used in the hot air tunnel system apparatus of the present invention is preferably a polyester-based heat-shrinkable label, for example, SKYROL™ heat-shrinkable film available from SKC Co. Ltd.

The hot air tunnel system apparatus of the present invention, and the labeling method using same, as described above comprise the preheating zone for preventing expansion of polyethylene-based products, the labeling zone for uniform shrinkage of a heat-shrinkable label, and the cooling zone for prevention of loose labels, which can minimize such labeling defects as loose labels, film curl, and irregular shrinkage.

The present invention is further described in the following examples. The examples, however, are given for the purpose of illustration only, and are not intended to limit the scope of the invention.

Hot air tunnel system apparatuses for heat-shrink labeling were prepared in accordance with Comparative Examples 1 and 2, and Examples 1 to 4, and the system configurations are summarized in Table 1 below.

### Comparative Example 1

### Hot Air Tunnel System Apparatus Equipped with Labeling Zone Only

A hot air tunnel system apparatus equipped with a labeling zone only was prepared as a conventional hot air tunnel system apparatus.

Specifically, the above apparatus was designed to convey a product to be labeled through the labeling zone by way of a conveyer belt while the labeling process takes place.

The temperature in the labeling zone was kept at 140° C. Fan heaters were provided on both sides of the labeling zone to blow hot air at a flow rate of 30 m/s. The speed of the conveyer belt was controlled to allow the product to stay for 1 minute in the labeling zone.

### Comparative Example 2

### Hot Air Tunnel System Apparatus Equipped with Preheating Zone and Labeling Zone

A hot air tunnel system apparatus equipped with a preheating zone and a labeling zone was prepared as another conventional hot air tunnel system apparatus.

Specifically, the above apparatus was designed to convey a product to be labeled through the preheating zone and the labeling zone in sequence by way of a conveyer belt while the labeling process takes place.

The temperatures in the preheating and labeling zones were kept at 60° C. and 140° C., respectively. Fan heaters were provided both sides of the preheating zone and of the labeling zone to blow a hot air at flow rates of 20 m/s and 30 m/s in the respective zones. The speed of conveyer belt was controlled to allow the product to stay for 30 seconds in each zone.

### Example 1

### Hot Air Tunnel System Apparatus Equipped with Preheating Zone, Labeling Zone, and Cooling Zone

In accordance with the present invention, a hot air tunnel system apparatus equipped with a preheating zone, a labeling zone, and a cooling zone was prepared.

Specifically, the above apparatus was designed to convey a product to be labeled through the preheating zone, the labeling zone, and the cooling zone, in sequence, by way of a conveyer belt while the labeling process takes place.

The temperatures in the preheating zone, the labeling zone and the cooling zone were kept at 60° C., 120° C., and 70° C., respectively. On both sides and on the bottom of each zone, fan heaters were provided to blow hot air at flow rates of 20 m/s, 30 m/s, and 30 m/s, in the respective zones. An air circulation system was provided on the top of each zone for the circulation of hot air therein. The speed of the conveyer belt was controlled to allow the product to stay for 30 seconds in each zone.

### Examples 2 to 4

### Hot Air Tunnel System Apparatuses Equipped with Preheating Zone, Labeling Zone and Cooling Zone

Hot air tunnel system apparatuses were prepared in the same manner as in Example 1 except that various temperatures, flow rates of hot air, and residence times of the products shown in Table 1 were employed.

### Heat-Shrink Labeling Process

The hot air tunnel system apparatuses of Comparative Examples 1 and 2 and of Examples 1 to 4 were used to label HDPE containers with heat-shrinkable labels.

Specifically, HDPE containers covered with heat-shrinkable labels were conveyed through the preheating zone, the labeling zone and/or the cooling zone of each apparatus in order to label said HDPE containers with the heat-shrinkable labels.

For the heat-shrinkable label, SKYROL® heat-shrinkable films available from SKC Co. Ltd. were used, and a typical shampoo bottle was used for the HDPE container.

### Test: Evaluation of Labeling Quality

In order to evaluate the heat-shrink labeling of the hot air tunnel system apparatuses of Comparative Examples 1 and 2 and of Examples 1 to 4, 1000 HDPE containers were labeled, and labeling defects were checked and categorized as loose labels, film curl or irregular shrinkage. As a result, there were some containers with 2 or more types of defects, and the defect rate was measured from the number of containers with 1 or more defects divided by the number of the entire containers. A defect rate of 1% or less was deemed as good.

TABLE 1

| | | | Comparative | | | | | |
|---|---|---|---|---|---|---|---|---|
| | | | Example | | Example | | | |
| Category | | Unit | 1 | 2 | 1 | 2 | 3 | 4 |
| Number of zone | | | 1 | 2 | 3 | 3 | 3 | 3 |
| Residence | Preheating zone | sec | 30 | 30 | 30 | 40 | 20 | 60 |
| time | Labeling zone | sec | — | 30 | 30 | 40 | 20 | 60 |
| | Cooling zone | sec | — | — | 30 | 40 | 20 | 60 |
| Flow rate of | Preheating zone | m/s | 30 | 20 | 20 | 20 | 10 | 10 |
| hot air | Labeling zone | m/s | — | 30 | 30 | 20 | 20 | 10 |
| | Cooling zone | m/s | — | — | 30 | 30 | 40 | 10 |
| Temperature | Preheating zone | ° C. | 140 | 60 | 60 | 50 | 70 | 50 |
| | Labeling zone | ° C. | — | 140 | 120 | 130 | 140 | 100 |
| | Cooling zone | ° C. | — | — | 70 | 60 | 60 | 60 |
| Heat-shrink | Total label | % | 100 | 90 | 0.6 | 0.5 | 0.4 | 0.4 |
| labeling | defects | | | | | | | |
| defects | Loose label | % | 100 | 90 | 0 | 0.4 | 0 | 0.4 |
| | Film curl | % | 50 | 30 | 0.5 | 0.3 | 0.3 | 0 |
| | Irregular | % | 60 | 20 | 0.3 | 0.2 | 0.3 | 0.2 |
| | shrinkage | | | | | | | |

As shown in Table 1, the rates of heat-shrink labeling defects (such as loose labels, film curl, and irregular shrinkage) of the inventive apparatuses of Examples 1 to 4 were remarkably low, i.e., 1% or lower, whereas the defect rates of the conventional apparatuses of Comparative Examples 1 and 2 were considerably high.

While the invention has been described with respect to the above specific embodiments, it should be recognized that various modifications and changes may be made to the invention by those skilled in the art which also fall within the scope of the invention as defined by the appended claims.

What is claimed is:

1. A hot air tunnel system apparatus comprising, in sequence, a preheating zone, a labeling zone, and a cooling zone, wherein said hot air tunnel system apparatus further comprises: a transporting member provided through the lower parts of said zones to convey a product in the direction from said preheating zone to said cooling zone, fan heaters provided on both sides and the bottom of each of said zones to blow hot air in each of said zones, and an air circulation system provided on the top of each of said zones to circulate hot air in each of said zones.

2. The hot air tunnel system apparatus of claim 1, wherein the temperature in said preheating zone is between 50 and 70° C.

3. The hot air tunnel system apparatus of claim 1, wherein the temperature in said labeling zone is between 100 and 140° C.

4. The hot air tunnel system apparatus of claim 1, wherein the temperature in said cooling zone is between 60 and 80° C.

5. The hot air tunnel system apparatus of claim 1 used for labeling a polyethylene-based product with a heat-shrinkable label.

6. A method for labeling a product with a heat-shrinkable label in the hot air tunnel system apparatus according to claim 1, which method comprises, in sequence, the steps of:
(a) preheating said product covered with said heat-shrinkable label in said preheating zone;
(b) subjecting said heat-shrinkable label to shrinkage to fit around said product; and
(c) cooling said product covered with said heat-shrunk label in said cooling zone.

7. The method of claim 6, wherein
the temperature in the preheating step (a) is between 50 and 70° C.;
the temperature in the labeling step (b) is between 100 and 140° C.; and
the temperature in the cooling step (c) is between 60 and 80° C.

8. The method of claim 6, wherein the product has a residence time between 3 seconds and 2 minutes in said preheating zone, said labeling zone, and said cooling zone.

9. The method of claim 6, wherein the product is a HDPE-based product.

10. The method of claim 6, wherein the heat-shrinkable label is a polyester-based heat-shrinkable label.
